(19) United States
(12) Patent Application Publication
(10) Pub. No.: US 2022/0243073 A1
(43) Pub. Date: Aug. 4, 2022

(54) MULTILAYERED FILM STRUCTURES WITH ANTI-MICROBIAL PROPERTIES

(71) Applicant: SAINT-GOBAIN PERFORMANCE PLASTICS CORPORATION, Solon, OH (US)

(72) Inventors: Yongzhong Wang, Tucson, AZ (US); Tad Bergstresser, Poway, CA (US); Matthew Gacek, San Diego, CA (US)

(21) Appl. No.: 17/648,738

(22) Filed: Jan. 24, 2022

Related U.S. Application Data
(60) Provisional application No. 63/143,285, filed on Jan. 29, 2021.

(51) Int. Cl. C09D 5/14; C09D 133/10; C09D 7/61; C08K 3/08

(52) U.S. Cl. CPC C09D 5/14; C09D 133/10; C08K 2003/0806; C08K 3/08; C09D 7/61

(57) ABSTRACT

The present disclosure relates a multilayered film that may include a first PET substrate, and a first anti-microbial coating overlying the first PET substrate. The first anti-microbial coating may include an acrylate-based component, and a silver-based filler component within the acrylate-based component. The first anti-microbial coating may have a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.

### CROSS-REFERENCE TO RELATED APPLICATION(S)

This application claims priority under 35 U.S.C. § 119(e) to U.S. Provisional Patent Application No. 63/143,285, entitled “MULTILAYERED FILM STRUCTURES WITH ANTI-MICROBIAL PROPERTIES,” by Yongzhong WANG et al., filed Jan. 29, 2021, which is assigned to the current assignee hereof and is incorporated by reference herein in its entirety.

### FIELD OF THE DISCLOSURE

The present disclosure relates to multilayer thin film layers having anti-microbial properties and composite structures that include such thin film layer having anti-microbial properties.

### BACKGROUND

Various microorganisms can cause sicknesses and the spread of these sicknesses often occurs due to the microorganisms' ability to survive on a surface for extended periods of time. Accordingly, multilayered film structures that can be applied to surfaces, in particular, surfaces located in medical buildings or on medical equipment, and which have anti-microbial properties are desirable.

### SUMMARY

According to a first aspect, a multilayered film may include a first PET substrate, a first anti-microbial coating overlying the first PET substrate, a first self-wetting adhesive layer underlying the first PET substrate, and at least one peelable multilayered film component overlying the first anti-microbial coating. The at least one peelable multilayered film component may include a peelable adhesive layer, a second PET substrate overlying the peelable adhesive layer, and a second anti-microbial coating overlying the second PET substrate. The first anti-microbial coating may include a silver-based filler component within the acrylate-based component. The first anti-microbial coating may have a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196. The second anti-microbial coating may include a silver-based filler component within the second anti-microbial coating. The second anti-microbial coating may have a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.

According to another aspect, a multilayered film may include a first PET substrate, a first anti-microbial coating overlying the first PET substrate, a first self-wetting adhesive layer underlying the first PET substrate, and at least one peelable multilayered film component overlying the first anti-microbial coating. The at least one peelable multilayered film component may include a peelable adhesive layer, a second PET substrate overlying the peelable adhesive layer, and a second anti-microbial coating overlying the second PET substrate. The first anti-microbial coating may include a silver-based filler component within the acrylate-based component. The first anti-microbial coating may have an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196. The second anti-microbial coating may include a silver-based filler component within the second anti-microbial coating. The second anti-microbial coating may have an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196.

According to still another aspect, a method of forming a multilayered film may include providing a first PET substrate, forming a first anti-microbial coating overlying the first PET substrate, forming a first self-wetting adhesive layer underlying the first PET substrate, and forming at least one peelable multilayered film component overlying the first anti-microbial coating. The at least one peelable multilayered film component may include a peelable adhesive layer, a second PET substrate overlying the peelable adhesive layer, and a second anti-microbial coating overlying the second PET substrate. The first anti-microbial coating may include a silver-based filler component within the acrylate-based component. The first anti-microbial coating may have a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196. The second anti-microbial coating may include a silver-based filler component within the second anti-microbial coating. The second anti-microbial coating may have a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.

According to still another aspect, a method of forming a multilayered film may include providing a first PET substrate, forming a first anti-microbial coating overlying the first PET substrate, forming a first self-wetting adhesive layer underlying the first PET substrate, and forming at least one peelable multilayered film component overlying the first anti-microbial coating. The at least one peelable multilayered film component may include a peelable adhesive layer, a second PET substrate overlying the peelable adhesive layer, and a second anti-microbial coating overlying the second PET substrate. The first anti-microbial coating may include a silver-based filler component within the acrylate-based component. The first anti-microbial coating may include an acrylate-based component, and a silver-based filler component within the acrylate-based component. The first anti-microbial coating may have an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196. The second anti-microbial coating may include a silver-based filler component within the second anti-microbial coating. The second anti-microbial coating may have an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196.

### BRIEF DESCRIPTION OF THE DRAWINGS

Embodiments are illustrated by way of example and are not limited to the accompanying figures.

FIG. 1a includes an illustration showing a diagram of a multilayered film according to embodiments described herein;

FIG. 1b includes an illustration showing a diagram of a multilayered film according to embodiments described herein;

FIG. 2 includes an illustration showing a diagram of a multilayered film according to embodiments described herein;

FIG. 3 includes a flow chart showing a method for forming a multilayered film according to embodiments described herein; and

FIG. 4 includes a flow chart showing a method for forming a multilayered film according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayered film that may include a base multilayered film and at least one peelable multilayered film component overlying the base multilayered film. According to certain embodiments, the base multilayered film may include a first PET substrate, a first anti-microbial coating overlying the first PET substrate, and a first self-wetting adhesive layer underlying the first PET substrate, where the first anti-microbial coating has particular anti-microbial properties. According to yet other embodiments, the at least one peelable multilayered film component may include a peelable adhesive layer overlying the first anti-microbial coating of the base multilayered film, a second PET substrate overlying the peelable adhesive layer, and a second anti-microbial coating overlying the second PET substrate, where the second anti-microbial coating has particular anti-microbial properties.

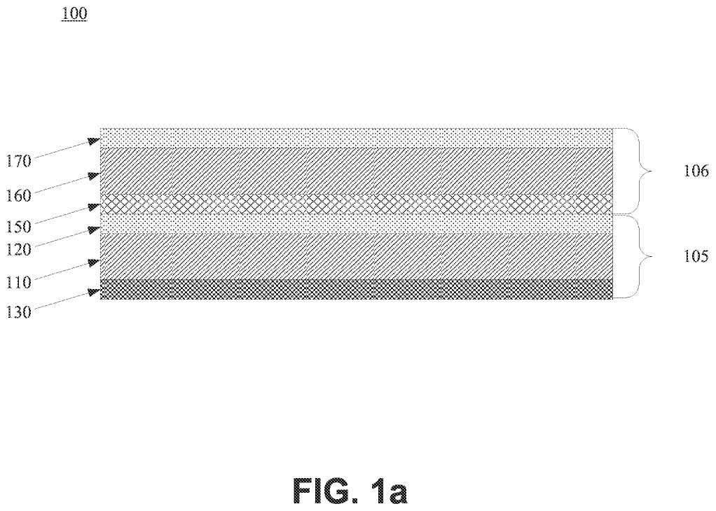

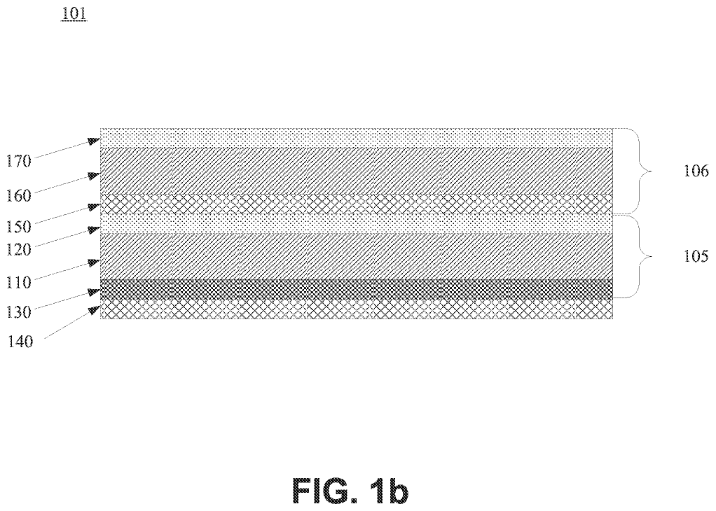

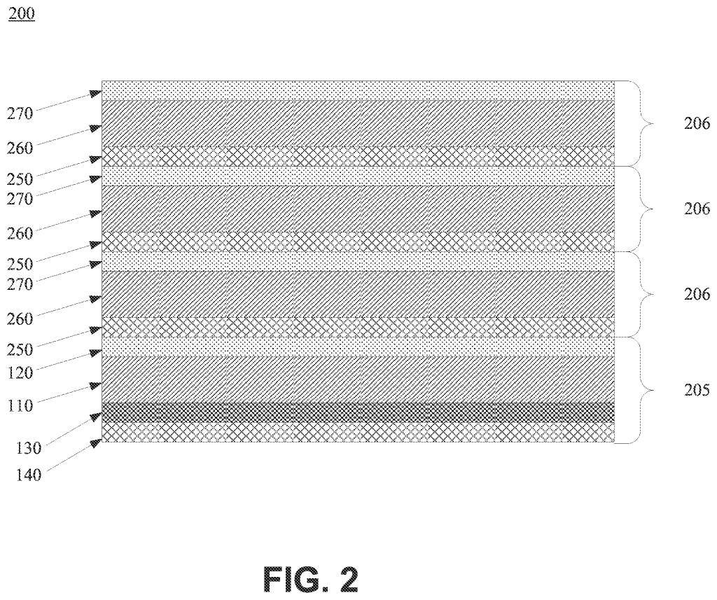

For purposes of illustration, FIG. 1a shows a multilayered film 100 according to embodiments described herein. As shown in FIG. 1a, a multilayered film 100 may include a base multilayered film 105 and at least one peelable multilayered film component 106 overlying the base multilayered film 105. As shown in FIG. 1a, the base multilayered film 105 may include a first PET substrate 110, a first anti-microbial coating 120 overlying the first PET substrate 110, and a first self-wetting adhesive layer 130 underlying the first PET substrate 110. As further shown in FIG. 2a, the peelable multilayered film component 106 may include a peelable adhesive layer 150 overlying the first anti-microbial coating 120 of the base multilayered film 105, a second PET substrate 160 overlying the peelable adhesive layer 150, and a second anti-microbial coating 170 overlying the second PET substrate 160.

According to particular embodiments, the first anti-microbial coating 120 may have a particular MRSA anti-microbial rating, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196. For example, the first anti-microbial coating 120 may have an MRSA anti-microbial rating of at least about 75%, such as, at least about 80% or at least about 85% or at least about 90% or at least about 95% or at least about 96% or at least about 97% or at least about 98% or even at least about 99%. It will be appreciated that the MRSA anti-microbial of the first anti-microbial coating 120 may be within a range between any of the values noted above. It will be further appreciated that the MRSA anti-microbial of the first anti-microbial coating 120 may be any value between any of the values noted above.

According to other embodiments, the first anti-microbial coating 120 may have a particular E. coli anti-microbial rating, where the E. coli anti-microbial rating is defined as the percent reduction of Escherichia coli (E. coli) activity from an initial inoculation of MRSA on the surface of the anti-microbial layer after 24 hours as measured using ISO22196. For example, the first anti-microbial coating 120 may have an E. coli anti-microbial rating of at least about 75%, such as, at least about 80% or at least about 85% or at least about 90% or at least about 95% or at least about 96% or at least about 97% or at least about 98% or even at least about 99%. It will be appreciated that the E. coli anti-microbial of the first anti-microbial coating 120 may be within a range between any of the values noted above. It will be further appreciated that the E. coli anti-microbial of the first anti-microbial coating 120 may be any value between any of the values noted above.

According to still other embodiments, the first anti-microbial coating 120 may include a silver-based filler component.

According to yet other embodiments, the silver-based filler component of the first anti-microbial coating 120 may include a particular material. For example, according to certain embodiments, the silver-based filler component of the first anti-microbial coating 120 may include silver. According to other embodiments, the silver-based filler component of the first anti-microbial coating 120 may include silver phosphate. According to yet other materials, the silver-based filler component of the first anti-microbial coating 120 may include a glass particle. According to still other embodiments, the silver-based filler component of the first anti-microbial coating 120 may include a silver phosphate glass particle, a silver zirconium phosphate silicate particle, or any combination thereof.

According to still other embodiments, the silver-based filler component of the first anti-microbial coating 120 may have a particular mean particle size as measured using a light scattering particle size testing device. For example, silver-based filler component of the first anti-microbial coating 120 may have a mean particle size of at least about 0.01 microns, such as, at least about 0.05 microns or at least about 0.1 microns or at least about 0.5 microns or at least about 1 micron or at least about 2 microns or at least about 3 microns or at least about 4 microns or at least about 5 microns or at least about 6 microns or at least about 7 microns or at least about 8 microns or at least about 9 microns or even at least about 10 microns. According to still other embodiments, the silver-based filler component of the first anti-microbial coating 120 may have a mean particle size of not greater than about 20 microns, such as, not greater than about 19 microns or not greater than about 18 microns or not greater than about 17 microns or not greater than about 16 microns or even not greater than about 15 microns. It will be appreciated that the mean particle size of the silver-based filler component of the first anti-microbial coating 120 may be within a range between any of the minimum and maximum values noted above. It will be further appreciated that the acrylate-based component content of the mean particle size of the silver-based filler component of the first anti-microbial coating 120 may be any value between any of the minimum and maximum values noted above.

According to yet other embodiments, the first anti-microbial coating 120 may include particular silver-based filler component content. For example, the first anti-microbial coating 120 may have a silver-based filler component content of at least about 0.1 wt. % for a total weight of the first anti-microbial coating 120, such as, at least about 0.2 wt. % or at least about 0.3 wt. % or at least about 0.4 wt. % or at least about 0.5 wt. % or at least about 0.6 wt. % or at least about 0.7 wt. % or even at least about 0.8 wt. %. According to yet other embodiments, the first anti-microbial coating 120 may have a silver-based filler component content of not greater than about 2.0 wt. % for a total weight of the first anti-microbial coating 120, such as, not greater than about 1.9 wt. % or not greater than about 1.8 wt. % or not greater than about 1.7 wt. % or not greater than about 1.6 wt. % or not greater than about 1.5 wt. % or not greater than about 1.4 wt. %. It will be appreciated that the silver-based filler component content of the first anti-microbial coating 120 may be within a range between any of the minimum and maximum values noted above. It will be further appreciated that the silver-based filler component content of the first anti-microbial coating 120 may be any value between any of the minimum and maximum values noted above.

According to still other embodiments, the first anti-microbial coating 120 may further include an acrylate-based component.

According to particular embodiments, the acrylate-based component of the first anti-microbial coating 120 may include an acrylate monomer. According to still other embodiments, the acrylate-based component of the first anti-microbial coating 120 may include monofunctional monomers, difunctional monomers, trifunctional monomers, tetrafunctional monomers, pentafunctional monomers, or any combination thereof. According to still other embodiments, the acrylate-based component of the first anti-microbial coating 120 may include an acrylate oligomer. According to still other embodiments, the acrylate-based component of the first anti-microbial coating 120 may include epoxy acrylate oligomers, epoxy methacrylate oligomers, polyester acrylate oligomers, urethane methacrylate oligomers, aliphatic urethane acrylate oligomers, aromatic urethane acrylate oligomers, halogenated acrylate oligomers, amine modified oligomers, or any combination thereof.

According to yet other embodiments, the first anti-microbial coating 120 may include particular acrylate-based component content. For example, the first anti-microbial coating 120 may have an acrylate-based component content of at least about 70 wt. % for a total weight of the first anti-microbial coating 120, such as, at least about 72 wt. % or at least about 74 wt. % or at least about 76 wt. % or at least about 78 wt. % or at least about 80 wt. % or at least about 82 wt. % or even at least about 84 wt. %. According to yet other embodiments, the first anti-microbial coating 120 may have an acrylate-based component content of not greater than about 98 wt. % for a total weight of the first anti-microbial coating 120, such as, not greater than about 96 wt. % or not greater than about 94 wt. % or not greater than about 92 wt. % or not greater than about 90 wt. % or not greater than about 88 wt. % or not greater than about 86 wt. %. It will be appreciated that the acrylate-based component content of the first anti-microbial coating 120 may be within a range between any of the minimum and maximum values noted above. It will be further appreciated that the acrylate-based component content of the first anti-microbial coating 120 may be any value between any of the minimum and maximum values noted above.

According to still other embodiments, the first anti-microbial coating 120 may further include a silicon acrylate.

According to particular embodiments, the first anti-microbial coating 120 may include a particular silicon acrylate content. For example, the first anti-microbial coating 120 may have a silicon acrylate content of at least about 0.1 wt. % for a total weight of the first anti-microbial coating 120, such as, at least about 0.2 wt. % or at least about 0.3 wt. % or at least about 0.4 wt. % or even at least about 0.5 wt. %. According to yet other embodiments, the first anti-microbial coating 120 may have a silicon acrylate content of not greater than about 1.0 wt. % for a total weight of the first anti-microbial coating 120, such as, not greater than about 0.9 wt. % or not greater than about 0.8 wt. % or even not greater than about 0.7 wt. %. It will be appreciated that the silicon acrylate content of the first anti-microbial coating 120 may be within a range between any of the minimum and maximum values noted above. It will be further appreciated that the silicon acrylate content of the first anti-microbial coating 120 may be any value between any of the minimum and maximum values noted above.

According to still other embodiments, the first anti-microbial coating 120 may further include an acrylated silicone.

According to particular embodiments, the first anti-microbial coating 120 may include a particular acrylated silicone content. For example, the first anti-microbial coating 120 may have an acrylated silicone content of at least about 0.1 wt. % for a total weight of the first anti-microbial coating 120, such as, at least about 0.2 wt. % or at least about 0.3 wt. % or at least about 0.4 wt. % or even at least about 0.5 wt. %. According to yet other embodiments, the first anti-microbial coating 120 may have an acrylated silicone content of not greater than about 1.0 wt. % for a total weight of the first anti-microbial coating 120, such as, not greater than about 0.9 wt. % or not greater than about 0.8 wt. % or even not greater than about 0.7 wt. %. It will be appreciated that the acrylated silicone content of the first anti-microbial coating 120 may be within a range between any of the minimum and maximum values noted above. It will be further appreciated that the acrylated silicone content of the first anti-microbial coating 120 may be any value between any of the minimum and maximum values noted above.

According to still other embodiments, the first anti-microbial coating 120 may further include a fluoro-containing acrylate.

According to particular embodiments, the first anti-microbial coating 120 may include a particular fluoro-containing acrylate content. For example, the first anti-microbial coating 120 may have an fluoro-containing acrylate content of at least about 10 wt. % for a total weight of the first anti-microbial coating 120, such as, at least about 11 wt. % or at least about 12 wt. % or at least about 13 wt. % or at least about 14 wt. % or even at least about 15 wt. %. According to yet other embodiments, the first anti-microbial coating 120 may have a fluoro-containing acrylate content of not greater than about 30 wt. % for a total weight of the first anti-microbial coating 120, such as, not greater than about 28 wt. % or not greater than about 26 wt. % or even not greater than about 24 wt. %. It will be appreciated that the fluoro-containing acrylate content of the first anti-microbial coating 120 may be within a range between any of the minimum and maximum values noted above. It will be further appreciated that the fluoro-containing acrylate content of the first anti-microbial coating 120 may be any value between any of the minimum and maximum values noted above.

According to still other embodiments, the first anti-microbial coating 120 may further include a UV absorber.

According to particular embodiments, the first anti-microbial coating 120 may include a particular UV absorber content. For example, the first anti-microbial coating 120 may have a UV absorber content of at least about 0.1 wt. % for a total weight of the first anti-microbial coating 120, such as, at least about 0.5 wt. % or at least about 1 wt. % or at least about 2 wt. % or even at least about 3 wt. %. According to yet other embodiments, the first anti-microbial coating 120 may have a UV absorber content of not greater than about 10 wt. % for a total weight of the first anti-microbial coating 120, such as, not greater than about 8 wt. % or not greater than about 6 wt. % or even not greater than about 4 wt. %. It will be appreciated that the UV absorber content of the first anti-microbial coating 120 may be within a range between any of the minimum and maximum values noted above. It will be further appreciated that the UV absorber content of the first anti-microbial coating 120 may be any value between any of the minimum and maximum values noted above.

According to still other embodiments, the first anti-microbial coating 120 may further include a UV stabilizer.

According to particular embodiments, the first anti-microbial coating 120 may include a particular UV stabilizer content. For example, the first anti-microbial coating 120 may have a UV stabilizer content of at least about 0.1 wt. % for a total weight of the first anti-microbial coating 120, such as, at least about 0.5 wt. % or at least about 1 wt. % or at least about 2 wt. % or even at least about 3 wt. %. According to yet other embodiments, the first anti-microbial coating 120 may have a UV stabilizer content of not greater than about 10 wt. % for a total weight of the first anti-microbial coating 120, such as, not greater than about 8 wt. % or not greater than about 6 wt. % or even not greater than about 4 wt. %. It will be appreciated that the UV stabilizer content of the first anti-microbial coating 120 may be within a range between any of the minimum and maximum values noted above. It will be further appreciated that the UV stabilizer content of the first anti-microbial coating 120 may be any value between any of the minimum and maximum values noted above.

According to still other embodiments, the first anti-microbial coating 120 may further include an anti-oxidant.

According to particular embodiments, the first anti-microbial coating 120 may include a particular anti-oxidant content. For example, the first anti-microbial coating 120 may have an anti-oxidant content of at least about 0.1 wt. % for a total weight of the first anti-microbial coating 120, such as, at least about 0.5 wt. % or at least about 1 wt. % or at least about 2 wt. % or even at least about 3 wt. %. According to yet other embodiments, the first anti-microbial coating 120 may have an anti-oxidant content of not greater than about 10 wt. % for a total weight of the first anti-microbial coating 120, such as, not greater than about 8 wt. % or not greater than about 6 wt. % or even not greater than about 4 wt. %. It will be appreciated that the anti-oxidant content of the first anti-microbial coating 120 may be within a range between any of the minimum and maximum values noted above. It will be further appreciated that the anti-oxidant content of the first anti-microbial coating 120 may be any value between any of the minimum and maximum values noted above.

According to still other embodiments, the first anti-microbial coating 120 may further include silica nanoparticles.

According to particular embodiments, the first anti-microbial coating 120 may include particular silica nanoparticles content. For example, the first anti-microbial coating 120 may have a silica nanoparticles content of at least about 0.1 wt. % for a total weight of the first anti-microbial coating 120, such as, at least about 0.5 wt. % or at least about 1 wt. % or at least about 2 wt. % or even at least about 3 wt. %. According to yet other embodiments, the first anti-microbial coating 120 may have a silica nanoparticles content of not greater than about 5 wt. % for a total weight of the first anti-microbial coating 120, such as, not greater than about 4.8 wt. % or not greater than about 4.5 wt. % or even not greater than about 4.0 wt. %. It will be appreciated that the silica nanoparticles content of the first anti-microbial coating 120 may be within a range between any of the minimum and maximum values noted above. It will be further appreciated that the silica nanoparticles content of the first anti-microbial coating 120 may be any value between any of the minimum and maximum values noted above.

According to still other embodiments, the first anti-microbial coating 120 may have a particular average thickness. For example, the first anti-microbial coating 120 may have an average thickness of at least about 2 microns, such as, at least about 2.5 microns or at least about 3.0 microns or at least about 3.5 microns or at least about 4.0 microns or at least about 4.5 microns or even at least about 5.0. According to still other embodiments, the first anti-microbial coating 120 may have an average thickness of not greater than about 10 microns, such as, not greater than about 9.5 microns or not greater than about 9.0 microns or not greater than about 8.5 microns or not greater than about 8.0 microns or not greater than about 7.5 microns or not greater than about 7.0 microns or not greater than about 6.5 microns or not greater than about 6.0 microns or even not greater than about 5.5. It will be appreciated that the average thickness of the first anti-microbial coating 120 may be within a range between any of the minimum and maximum values noted above. It will be further appreciated that the average thickness of the first anti-microbial coating 120 may be any value between any of the minimum and maximum values noted above.

According to still other embodiments, the first anti-microbial coating 120 may have a particular VLT as measured according to ASTM D1003. For example, the first anti-microbial coating 120 may have a VLT of at least about 85%, such as, at least about 86% or at least about 87% or at least about 88% or at least about 89% or even at least about 90%. According to still other embodiments, the first anti-microbial coating 120 may have a VLT of not greater than about 94%. It will be appreciated that the VLT of the first anti-microbial coating 120 may be within a range between any of the minimum and maximum values noted above. It will be further appreciated that the VLT of the first anti-microbial coating 120 may be any value between any of the minimum and maximum values noted above.

According to still other embodiments, the multilayered film 100 may have a particular VLT as measured according to ASTM D1003. For example, the multilayered film 100 may have a VLT of at least about 85%, such as, at least about 86% or at least about 87% or at least about 88% or at least about 89% or even at least about 90%. According to still other embodiments, the multilayered film 100 may have a VLT of not greater than about 94%. It will be appreciated that the VLT of the multilayered film 100 may be within a range between any of the minimum and maximum values noted above. It will be further appreciated that the VLT of the multilayered film 100 may be any value between any of the minimum and maximum values noted above.

According to still other embodiments, the first anti-microbial coating 120 may have a particular haze value as measured according to ASTM D1003. For example, the first anti-microbial coating 120 may have a haze value of at least about 0.2%, such as, at least about 0.3% or at least about 0.4% or at least about 0.5% or at least about 0.6% or at least about 0.7% or at least about 0.8% or at least about 0.9% or even at least about 1.0%. According to still other embodiments, the first anti-microbial coating 120 may have a haze value of not greater than about 2.0%. It will be appreciated that the haze value of the first anti-microbial coating 120 may be within a range between any of the minimum and maximum values noted above. It will be further appreciated that the haze value of the first anti-microbial coating 120 may be any value between any of the minimum and maximum values noted above.

According to still other embodiments, the multilayered film 100 may have a particular haze value as measured according to ASTM D1003. For example, the multilayered film 100 may have a haze value of at least about 0.2%, such as, at least about 0.3% or at least about 0.4% or at least about 0.5% or at least about 0.6% or at least about 0.7% or at least about 0.8% or at least about 0.9% or even at least about 1.0%. According to still other embodiments, the multilayered film 100 may have a haze value of not greater than about 2.0%. It will be appreciated that the haze value of the multilayered film 100 may be within a range between any of the minimum and maximum values noted above. It will be further appreciated that the haze value of the multilayered film 100 may be any value between any of the minimum and maximum values noted above.

According to still other embodiments, the first anti-microbial coating 120 may have a particular water contact angle as measured using a water contact angle tester. For example, the first anti-microbial coating 120 may have a water contact angle of at least about 70°, such as, at least about 73° or at least about 75° or at least about 78° or at least about 80° or at least about 83° or at least about 85° or at least about 88° or even at least about 90°. According to still other embodiments, the first anti-microbial coating 120 may have a water contact angle of not greater than about 110°. It will be appreciated that the water contact angle of the first anti-microbial coating 120 may be within a range between any of the minimum and maximum values noted above. It will be further appreciated that the water contact angle of the first anti-microbial coating 120 may be any value between any of the minimum and maximum values noted above.

According to still other embodiments, the multilayered film 100 may have a particular water contact angle as measured according to a water contact angle tester. For example, the multilayered film 100 may have a water contact angle of at least about 70°, such as, at least about 73° or at least about 75° or at least about 78° or at least about 80° or at least about 83° or at least about 85° or at least about 88° or even at least about 90°. According to still other embodiments, the multilayered film 100 may have a water contact angle of not greater than about 110°. It will be appreciated that the water contact angle of the multilayered film 100 may be within a range between any of the minimum and maximum values noted above. It will be further appreciated that the water contact angle of the multilayered film 100 may be any value between any of the minimum and maximum values noted above.

According to particular embodiments, the first self-wetting adhesive layer 130 may include an acrylic-based adhesive, a silicone-based adhesive, or any combination thereof.

According to certain embodiments, the first self-wetting adhesive layer 130 may be an acrylic-based adhesive layer. According to still other embodiments, the first self-wetting adhesive layer 130 may consist essentially of an acrylic-based layer.

According to certain embodiments, the first self-wetting adhesive layer 130 may be a silicone-based adhesive layer. According to still other embodiments, the first self-wetting adhesive layer 130 may consist essentially of a silicone-based layer.

According to yet other embodiments, the first self-wetting adhesive layer 130 may have a particular average thickness. For example, the first self-wetting adhesive layer 130 may have an average thickness of at least about 0.1 mils, such as, at least about 0.3 mils or at least about 0.5 mils or at least about 0.8 mils or at least about 1.0 mils or at least about 1.3 mils or even at least about 1.5 mils. According to still other embodiments, the first pressure sensitive adhesive layer 130 may have an average thickness of not greater than about 5 mils, such as, not greater than about 4.8 mils or not greater than about 4.5 mils or not greater than about 4.3 mils or not greater than about 4.0 mils or not greater than about 3.8 mils or not greater than about 3.5 mils or not greater than about 3.3 mils or not greater than about 3.0 mils not greater than about 2.8 mils or not greater than about 2.5 mils or not greater than about 2.3 mils or even not greater than about 2.0 mils. It will be appreciated that the average thickness of the first self-wetting adhesive layer 130 of the multilayered film 100 may be within a range between any of the minimum and maximum values noted above. It will be further appreciated that the average thickness of the first self-wetting adhesive layer 130 of the multilayered film 100 may be any value between any of the minimum and maximum values noted above.

According to still other embodiments, the first self-wetting adhesive layer 130 may have a particular peel strength as measured according to ASTM D903-98. According to particular embodiments, the first self-wetting adhesive layer 130 may have a peel strength of at least about 0.5 g/in, such as, at least about 1.0 g/in or at least about 5 g/in or at least about 10 g/in or at least about 50 g/in or at least about 100 g/in or at least about 200 g/in or at least about 300 g/in or at least about 400 g/in or even at least about 500 g/in. According to still other embodiments, the first self-wetting adhesive layer 130 may have a peel strength of not greater than about 1000 g/in, such as, not greater than about 900 g/in or not greater than about 800 g/in or not greater than about 700 g/in or not greater than about 600 g/in. It will be appreciated that the peel strength of the first self-wetting adhesive layer 130 of the multilayered film 100 may be within a range between any of the minimum and maximum values noted above. It will be further appreciated that the peel strength of the first self-wetting adhesive layer 130 of the multilayered film 100 may be any value between any of the minimum and maximum values noted above.

According to particular embodiments, the second anti-microbial 170 may have a particular MRSA anti-microbial rating, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196. For example, the second anti-microbial 170 may have an MRSA anti-microbial rating of at least about 75%, such as, at least about 80% or at least about 85% or at least about 90% or at least about 95% or at least about 96% or at least about 97% or at least about 98% or even at least about 99%. It will be appreciated that the MRSA anti-microbial of the second anti-microbial 170 may be within a range between any of the values noted above. It will be further appreciated that the MRSA anti-microbial of the second anti-microbial 170 may be any value between any of the values noted above.

According to other embodiments, the second anti-microbial 170 may have a particular E. coli anti-microbial rating, where the E. coli anti-microbial rating is defined as the percent reduction of Escherichia coli (E. coli) activity from an initial inoculation of MRSA on the surface of the anti-microbial layer after 24 hours as measured using ISO22196. For example, the second anti-microbial 170 may have an E. coli anti-microbial rating of at least about 75%, such as, at least about 80% or at least about 85% or at least about 90% or at least about 95% or at least about 96% or at least about 97% or at least about 98% or even at least about 99%. It will be appreciated that the E. coli anti-microbial of the second anti-microbial 170 may be within a range between any of the values noted above. It will be further appreciated that the E. coli anti-microbial of the second anti-microbial 170 may be any value between any of the values noted above.

According to still other embodiments, the second anti-microbial 170 may include a silver-based component.

According to yet other embodiments, the silver-based filler component of the second anti-microbial 170 may include a particular material. For example, according to certain embodiments, the silver-based filler component of the second anti-microbial 170 may include silver. According to other embodiments, the silver-based filler component of the second anti-microbial 170 may include silver phosphate. According to yet other materials, the silver-based filler component of the second anti-microbial 170 may include a glass particle. According to still other embodiments, the silver-based filler component of the second anti-microbial 170 may include a silver phosphate glass particle, a silver zirconium phosphate silicate particle, or any combination thereof.

According to still other embodiments, the silver-based filler component of the second anti-microbial 170 may have a particular mean particle size as measured using a light scattering particle size testing device. For example, silver-based filler component of the second anti-microbial 170 may have a mean particle size of at least about 0.01 microns, such as, at least about 0.05 microns or at least about 0.1 microns or at least about 0.5 microns or at least about 1 micron or at least about 2 microns or at least about 3 microns or at least about 4 microns or at least about 5 microns or at least about 6 microns or at least about 7 microns or at least about 8 microns or at least about 9 microns or even at least about 10 microns. According to still other embodiments, the silver-based filler component of the second anti-microbial 170 may have a mean particle size of not greater than about 20 microns, such as, not greater than about 19 microns or not greater than about 18 microns or not greater than about 17 microns or not greater than about 16 microns or even not greater than about 15 microns. It will be appreciated that the mean particle size of the silver-based filler component of the second anti-microbial 170 may be within a range between any of the minimum and maximum values noted above. It will be further appreciated that the acrylate-based component content of the mean particle size of the silver-based filler component of the second anti-microbial 170 may be any value between any of the minimum and maximum values noted above.

According to yet other embodiments, the second anti-microbial 170 may include particular silver-based filler component content. For example, the second anti-microbial 170 may have a silver-based filler component content of at least about 0.1 wt. % for a total weight of the second anti-microbial 170, such as, at least about 0.2 wt. % or at least about 0.3 wt. % or at least about 0.4 wt. % or at least about 0.5 wt. % or at least about 0.6 wt. % or at least about 0.7 wt. % or even at least about 0.8 wt. %. According to yet other embodiments, the second anti-microbial 170 may have a silver-based filler component content of not greater than about 2.0 wt. % for a total weight of the second anti-microbial 170, such as, not greater than about 1.9 wt. % or not greater than about 1.8 wt. % or not greater than about 1.7 wt. % or not greater than about 1.6 wt. % or not greater than about 1.5 wt. % or not greater than about 1.4 wt. %. It will be appreciated that the silver-based filler component content of the second anti-microbial 170 may be within a range between any of the minimum and maximum values noted above. It will be further appreciated that the silver-based filler component content of the second anti-microbial 170 may be any value between any of the minimum and maximum values noted above.

According to still other embodiments, the second anti-microbial coating 170 may further include an acrylate-based component.

According to particular embodiments, the acrylate-based component of the second anti-microbial coating 170 may include an acrylate monomer. According to still other embodiments, the acrylate-based component of the second anti-microbial coating 170 may include monofunctional monomers, difunctional monomers, trifunctional monomers, tetrafunctional monomers, pentafunctional monomers, or any combination thereof. According to still other embodiments, the acrylate-based component of the second anti-microbial coating 170 may include an acrylate oligomer. According to still other embodiments, the acrylate-based component of the second anti-microbial coating 170 may include epoxy acrylate oligomers, epoxy methacrylate oligomers, polyester acrylate oligomers, urethane methacrylate oligomers, aliphatic urethane acrylate oligomers, aromatic urethane acrylate oligomers, halogenated acrylate oligomers, amine modified oligomers, or any combination thereof.

According to yet other embodiments, the second anti-microbial coating 170 may include particular acrylate-based component content. For example, the second anti-microbial coating 170 may have an acrylate-based component content of at least about 70 wt. % for a total weight of the second anti-microbial coating 170, such as, at least about 72 wt. % or at least about 74 wt. % or at least about 76 wt. % or at least about 78 wt. % or at least about 80 wt. % or at least about 82 wt. % or even at least about 84 wt. %. According to yet other embodiments, the second anti-microbial coating 170 may have an acrylate-based component content of not greater than about 98 wt. % for a total weight of the second anti-microbial coating 170, such as, not greater than about 96 wt. % or not greater than about 94 wt. % or not greater than about 92 wt. % or not greater than about 90 wt. % or not greater than about 88 wt. % or not greater than about 86 wt. %. It will be appreciated that the acrylate-based component content of the second anti-microbial coating 170 may be within a range between any of the minimum and maximum values noted above. It will be further appreciated that the acrylate-based component content of the second anti-microbial coating 170 may be any value between any of the minimum and maximum values noted above.

According to still other embodiments, the second anti-microbial 170 may further include a silicon acrylate.

According to particular embodiments, the second anti-microbial 170 may include a particular silicon acrylate content. For example, the second anti-microbial 170 may have a silicon acrylate content of at least about 0.1 wt. % for a total weight of the second anti-microbial 170, such as, at least about 0.2 wt. % or at least about 0.3 wt. % or at least about 0.4 wt. % or even at least about 0.5 wt. %. According to yet other embodiments, the second anti-microbial 170 may have a silicon acrylate content of not greater than about 1.0 wt. % for a total weight of the second anti-microbial 170, such as, not greater than about 0.9 wt. % or not greater than about 0.8 wt. % or even not greater than about 0.7 wt. %. It will be appreciated that the silicon acrylate content of the second anti-microbial 170 may be within a range between any of the minimum and maximum values noted above. It will be further appreciated that the silicon acrylate content of the second anti-microbial 170 may be any value between any of the minimum and maximum values noted above.

According to still other embodiments, the second anti-microbial 170 may further include an acrylated silicone.

According to particular embodiments, the second anti-microbial 170 may include a particular acrylated silicone content. For example, the second anti-microbial 170 may have an acrylated silicone content of at least about 0.1 wt. % for a total weight of the second anti-microbial 170, such as, at least about 0.2 wt. % or at least about 0.3 wt. % or at least about 0.4 wt. % or even at least about 0.5 wt. %. According to yet other embodiments, the second anti-microbial 170 may have an acrylated silicone content of not greater than about 1.0 wt. % for a total weight of the second anti-microbial 170, such as, not greater than about 0.9 wt. % or not greater than about 0.8 wt. % or even not greater than about 0.7 wt. %. It will be appreciated that the acrylated silicone content of the second anti-microbial 170 may be within a range between any of the minimum and maximum values noted above. It will be further appreciated that the acrylated silicone content of the second anti-microbial 170 may be any value between any of the minimum and maximum values noted above.

According to still other embodiments, the second anti-microbial 170 may further include a fluoro-containing acrylate.

According to particular embodiments, the second anti-microbial 170 may include a particular fluoro-containing acrylate content. For example, the second anti-microbial 170 may have an fluoro-containing acrylate content of at least about 10 wt. % for a total weight of the second anti-microbial 170, such as, at least about 11 wt. % or at least about 12 wt. % or at least about 13 wt. % or at least about 14 wt. % or even at least about 15 wt. %. According to yet other embodiments, the second anti-microbial 170 may have a fluoro-containing acrylate content of not greater than about 30 wt. % for a total weight of the second anti-microbial 170, such as, not greater than about 28 wt. % or not greater than about 26 wt. % or even not greater than about 24 wt. %. It will be appreciated that the fluoro-containing acrylate content of the second anti-microbial 170 may be within a range between any of the minimum and maximum values noted above. It will be further appreciated that the fluoro-containing acrylate content of the second anti-microbial 170 may be any value between any of the minimum and maximum values noted above.

According to still other embodiments, the second anti-microbial 170 may further include a UV absorber.

According to particular embodiments, the second anti-microbial 170 may include a particular UV absorber content. For example, the second anti-microbial 170 may have a UV absorber content of at least about 0.1 wt. % for a total weight of the second anti-microbial 170, such as, at least about 0.5 wt. % or at least about 1 wt. % or at least about 2 wt. % or even at least about 3 wt. %. According to yet other embodiments, the second anti-microbial 170 may have a UV absorber content of not greater than about 10 wt. % for a total weight of the second anti-microbial 170, such as, not greater than about 8 wt. % or not greater than about 6 wt. % or even not greater than about 4 wt. %. It will be appreciated that the UV absorber content of the second anti-microbial 170 may be within a range between any of the minimum and maximum values noted above. It will be further appreciated that the UV absorber content of the second anti-microbial 170 may be any value between any of the minimum and maximum values noted above.

According to still other embodiments, the second anti-microbial 170 may further include a UV stabilizer.

According to particular embodiments, the second anti-microbial 170 may include a particular UV stabilizer content. For example, the second anti-microbial 170 may have a UV stabilizer content of at least about 0.1 wt. % for a total weight of the second anti-microbial 170, such as, at least about 0.5 wt. % or at least about 1 wt. % or at least about 2 wt. % or even at least about 3 wt. %. According to yet other embodiments, the second anti-microbial 170 may have a UV stabilizer content of not greater than about 10 wt. % for a total weight of the second anti-microbial 170, such as, not greater than about 8 wt. % or not greater than about 6 wt. % or even not greater than about 4 wt. %. It will be appreciated that the UV stabilizer content of the second anti-microbial 170 may be within a range between any of the minimum and maximum values noted above. It will be further appreciated that the UV stabilizer content of the second anti-microbial 170 may be any value between any of the minimum and maximum values noted above.

According to still other embodiments, the second anti-microbial 170 may further include an anti-oxidant.

According to particular embodiments, the second anti-microbial 170 may include a particular anti-oxidant content. For example, the second anti-microbial 170 may have an anti-oxidant content of at least about 0.1 wt. % for a total weight of the second anti-microbial 170, such as, at least about 0.5 wt. % or at least about 1 wt. % or at least about 2 wt. % or even at least about 3 wt. %. According to yet other embodiments, the second anti-microbial 170 may have an anti-oxidant content of not greater than about 10 wt. % for a total weight of the second anti-microbial 170, such as, not greater than about 8 wt. % or not greater than about 6 wt. % or even not greater than about 4 wt. %. It will be appreciated that the anti-oxidant content of the second anti-microbial 170 may be within a range between any of the minimum and maximum values noted above. It will be further appreciated that the anti-oxidant content of the second anti-microbial 170 may be any value between any of the minimum and maximum values noted above.

According to still other embodiments, the second anti-microbial 170 may further include silica nanoparticles.

According to particular embodiments, the second anti-microbial 170 may include particular silica nanoparticles content. For example, the second anti-microbial 170 may have a silica nanoparticles content of at least about 0.1 wt. % for a total weight of the second anti-microbial 170, such as, at least about 0.5 wt. % or at least about 1 wt. % or at least about 2 wt. % or even at least about 3 wt. %. According to yet other embodiments, the second anti-microbial 170 may have a silica nanoparticles content of not greater than about 5 wt. % for a total weight of the second anti-microbial 170, such as, not greater than about 4.8 wt. % or not greater than about 4.5 wt. % or even not greater than about 4.0 wt. %. It will be appreciated that the silica nanoparticles content of the second anti-microbial 170 may be within a range between any of the minimum and maximum values noted above. It will be further appreciated that the silica nanoparticles content of the second anti-microbial 170 may be any value between any of the minimum and maximum values noted above.

According to still other embodiments, the second anti-microbial 170 may have a particular average thickness. For example, the second anti-microbial 170 may have an average thickness of at least about 2 microns, such as, at least about 2.5 microns or at least about 3.0 microns or at least about 3.5 microns or at least about 4.0 microns or at least about 4.5 microns or even at least about 5.0. According to still other embodiments, the second anti-microbial 170 may have an average thickness of not greater than about 10 microns, such as, not greater than about 9.5 microns or not greater than about 9.0 microns or not greater than about 8.5 microns or not greater than about 8.0 microns or not greater than about 7.5 microns or not greater than about 7.0 microns or not greater than about 6.5 microns or not greater than about 6.0 microns or even not greater than about 5.5. It will be appreciated that the average thickness of the second anti-microbial 170 may be within a range between any of the minimum and maximum values noted above. It will be further appreciated that the average thickness of the second anti-microbial 170 may be any value between any of the minimum and maximum values noted above.

According to still other embodiments, the second anti-microbial 170 may have a particular VLT as measured according to ASTM D1003. For example, the second anti-microbial 170 may have a VLT of at least about 85%, such as, at least about 86% or at least about 87% or at least about 88% or at least about 89% or even at least about 90%. According to still other embodiments, the second anti-microbial 170 may have a VLT of not greater than about 94%. It will be appreciated that the VLT of the second anti-microbial 170 may be within a range between any of the minimum and maximum values noted above. It will be further appreciated that the VLT of the second anti-microbial 170 may be any value between any of the minimum and maximum values noted above.

According to still other embodiments, the multilayered film 100 may have a particular VLT as measured according to ASTM D1003. For example, the multilayered film 100 may have a VLT of at least about 85%, such as, at least about 86% or at least about 87% or at least about 88% or at least about 89% or even at least about 90%. According to still other embodiments, the multilayered film 100 may have a VLT of not greater than about 94%. It will be appreciated that the VLT of the multilayered film 100 may be within a range between any of the minimum and maximum values noted above. It will be further appreciated that the VLT of the multilayered film 100 may be any value between any of the minimum and maximum values noted above.

According to still other embodiments, the second anti-microbial 170 may have a particular haze value as measured according to ASTM D1003. For example, the second anti-microbial 170 may have a haze value of at least about 0.2%, such as, at least about 0.3% or at least about 0.4% or at least about 0.5% or at least about 0.6% or at least about 0.7% or at least about 0.8% or at least about 0.9% or even at least about 1.0%. According to still other embodiments, the second anti-microbial 170 may have a haze value of not greater than about 2.0%. It will be appreciated that the haze value of the second anti-microbial 170 may be within a range between any of the minimum and maximum values noted above. It will be further appreciated that the haze value of the second anti-microbial 170 may be any value between any of the minimum and maximum values noted above.

According to still other embodiments, the multilayered film 100 may have a particular haze value as measured according to ASTM D1003. For example, the multilayered film 100 may have a haze value of at least about 0.2%, such as, at least about 0.3% or at least about 0.4% or at least about 0.5% or at least about 0.6% or at least about 0.7% or at least about 0.8% or at least about 0.9% or even at least about 1.0%. According to still other embodiments, the multilayered film 100 may have a haze value of not greater than about 2.0%. It will be appreciated that the haze value of the multilayered film 100 may be within a range between any of the minimum and maximum values noted above. It will be further appreciated that the haze value of the multilayered film 100 may be any value between any of the minimum and maximum values noted above.

According to still other embodiments, the second anti-microbial 170 may have a particular water contact angle as measured using a water contact angle tester. For example, the second anti-microbial 170 may have a water contact angle of at least about 70°, such as, at least about 73° or at least about 75° or at least about 78° or at least about 80° or at least about 83° or at least about 85° or at least about 88° or even at least about 90°. According to still other embodiments, the second anti-microbial 170 may have a water contact angle of not greater than about 110°. It will be appreciated that the water contact angle of the second anti-microbial 170 may be within a range between any of the minimum and maximum values noted above. It will be further appreciated that the water contact angle of the second anti-microbial 170 may be any value between any of the minimum and maximum values noted above.

According to still other embodiments, the multilayered film 100 may have a particular water contact angle as measured using a water contact angle tester. For example, the multilayered film 100 may have a water contact angle of at least about 70°, such as, at least about 73° or at least about 75° or at least about 78° or at least about 80° or at least about 83° or at least about 85° or at least about 88° or even at least about 90°. According to still other embodiments, the multilayered film 100 may have a water contact angle of not greater than about 110°. It will be appreciated that the water contact angle of the multilayered film 100 may be within a range between any of the minimum and maximum values noted above. It will be further appreciated that the water contact angle of the multilayered film 100 may be any value between any of the minimum and maximum values noted above.

According to particular embodiments, the peelable adhesive layer 150 may include a pressure sensitive adhesive. According to yet other embodiments, the peelable adhesive layer 150 may include an acrylic adhesive.

According to yet other embodiments, the peelable adhesive layer 150 may have a particular average thickness. For example, the peelable adhesive layer 150 may have an average thickness of at least about 0.5 mils, such as, at least about 0.8 mils or at least about 1.0 mils or at least about 1.3 mils or even at least about 1.5 mils. According to still other embodiments, the peelable adhesive layer 150 may have an average thickness of not greater than about 3 mils, such as, not greater than about 2.8 mils or not greater than about 2.5 mils or not greater than about 2.3 mils or even not greater than about 2.0 mils. It will be appreciated that the average thickness of the peelable adhesive layer 150 of the multilayered film 101 may be within a range between any of the minimum and maximum values noted above. It will be further appreciated that the water contact angle of the peelable adhesive layer 150 of the multilayered film 101 may be any value between any of the minimum and maximum values noted above.

According to still other embodiments, the peelable adhesive layer 150 may have particular peel strength as measured according to ASTM D903-98. For example, the peelable adhesive layer 150 may have a peel strength of at least about 5 g/in, such as, at least about 10 g/in or at least about 15 g/in or at least about 20 g/in or at least about 25 g/in or at least about 30 g/in or at least about 35 g/in or even at least about 40 g/in. According to still other embodiments, the peelable adhesive layer 240 may have a peel strength of not greater than about 100 g/in, such as, not greater than about 95 g/in or not greater than about 90 g/in or not greater than about 85 g/in or not greater than about 80 g/in or not greater than about 75 g/in or even not greater than about 70 g/in.

For purposes of further illustration, FIG. 1b shows a multilayered film 101 according to other embodiments described herein. As shown in FIG. 1b, a multilayered film 101 may include a base multilayered film 105 and at least one peelable multilayered film component 106 overlying the base multilayered film 204. As shown in FIG. 1b, the base multilayered film 105 may include a first PET substrate 110, a first anti-microbial coating 120 overlying the first PET substrate 110, a first self-wetting adhesive layer 130 underlying the first PET substrate, and a liner 140 underlying the first self-wetting adhesive layer 130. As further shown in FIG. 1b, the peelable multilayered film component 106 may include a peelable adhesive layer 150 overlying the first anti-microbial coating 120 of the base multilayered film 105, a second PET substrate 160 overlying the peelable adhesive layer 150, and a second anti-microbial coating 170 overlying the second PET substrate 160.

It will be appreciated that any component of FIG. 1b that correspond to a component of FIG. 1a may have any of the characteristics described in reference to that component of FIG. 1a. For example, the first PET substrate 110, the first anti-microbial coating 120, the first self-wetting adhesive layer 130, the peelable multilayered film component 106, the peelable adhesive layer 150, the second PET substrate 160, and the second anti-microbial coating 170 of FIG. 1b may have any of the characteristics described in reference to the first PET substrate 110, the first anti-microbial coating 120, the first self-wetting adhesive layer 130, the peelable multilayered film component 106, the peelable adhesive layer 150, the second PET substrate 160, and the second anti-microbial coating 170 of FIG. 1a.

According to particular embodiments, the multilayered film 201 may have a particular adhesive strength ratio PS_{PAL}/PS_{BAL}, where PS_{BAL} is equal to the peel strength of the first self-wetting adhesive layer 130 in grams per inch and PS_{PAL} is equal to the peel strength of the peelable adhesive layer 150 of the peelable multilayered film component 106 in grams per inch. For example, the multilayered film 101 may have an adhesive strength ratio PS_{PAL}/PS_{BAL} of not greater than about 0.98, such as, not greater than about 0.95 or not greater than about 0.93 or not greater than about 0.90 or not greater than about 0.88 or not greater than about 0.85 or not greater than about 0.83 or not greater than about 0.80 or not greater than about 0.78 or not greater than about 0.75. According to still other embodiments, the multilayered film 101 may have an adhesive strength ratio PS_{PAL}/PS_{BAL} of at least about 0.25, such as, at least about 0.28 or at least about 0.3 or at least about 0.33 or at least about 0.35 or at least about 0.38 or at least about 0.4 or at least about 0.43 or at least about 0.45 or at least about 0.48 or at least about 0.5. It will be appreciated that the adhesive strength ratio PS_{PAL}/PS_{BAL} of the multilayered film 201 may be within a range between any of the minimum and maximum values noted above. It will be further appreciated that the adhesive strength ratio PS_{PAL}/PS_{BAL} of the multilayered film 201 may be any value between any of the minimum and maximum values noted above.

Turning now to alternative embodiments described herein, such embodiments may be generally directed to a base multilayered film with multiple peelable multilayered film components overlying a base multilayered film. According to certain embodiments, the base multilayered film may include a first PET substrate, a first anti-microbial coating overlying the first PET substrate, and a first self-wetting adhesive layer underlying the first PET substrate, where the first anti-microbial coating has particular anti-microbial properties. According to yet other embodiments, each of the multiple peelable multilayered film components may include a peelable adhesive layer overlying the first anti-microbial coating of the base multilayered film, a second PET substrate overlying the peelable adhesive layer, and a second anti-microbial coating overlying the second PET substrate, where the second anti-microbial coating has particular anti-microbial properties.

According to certain embodiments, a multilayered film may include a base multilayered film and at least two peelable multilayered film components overlying the base multilayered film. According to another embodiment, a multilayered film may include a base multilayered film and at least three peelable multilayered film components overlying the base multilayered film. According to another embodiment, a multilayered film may include a base multilayered film and at least four peelable multilayered film components overlying the base multilayered film. According to another embodiment, a multilayered film may include a base multilayered film and at least five peelable multilayered film components overlying the base multilayered film. According to another embodiment, a multilayered film may include a base multilayered film and at least six peelable multilayered film components overlying the base multilayered film. It will be appreciated that the multilayered film may include any desirable number of peelable multilayered film components overlying the base multilayered film.

For purposes of illustration, FIG. 2 shows a multilayered film 200 according to embodiments described herein, where the multilayered film 200 includes a base multilayered film 205 and three peelable multilayered film components 206 overlying the base multilayered film 205. As shown in FIG. 2, the base multilayered film 205 may include a first PET substrate 110, a first anti-microbial coating 120 overlying the first PET substrate 110, a first self-wetting adhesive layer 130 underlying the first PET substrate 110, and a liner 140 underlying the first self-wetting adhesive layer 130. As further shown in FIG. 2, each of the three peelable multilayered film components 206 may include a peelable adhesive layer 250 overlying the first anti-microbial coating 120 of the base multilayered film 205 (or the second anti-microbial coating 270 of the underlying peelable multilayered film component 206), a second PET substrate 260 overlying the peelable adhesive layer 250, and a second anti-microbial coating 270 overlying the second PET substrate 260.

It will be appreciated that any component of FIG. 2 that correspond to a component of FIGS. 1a, and/or 1b, may have any of the characteristics described in reference to that component of FIGS. 1a, and/or 1b. For example, the first PET substrate 110, the first anti-microbial coating 120, the first self-wetting adhesive layer 130, the peelable multilayered film component 206, the peelable adhesive layer 250, the second PET substrate 260, and the second anti-microbial coating 270 of FIG. 2 may have any of the characteristics described in reference to the first PET substrate 110, the first anti-microbial coating 120, the first self-wetting adhesive layer 130, the peelable multilayered film component 206, the peelable adhesive layer 250, the second PET substrate 260, and the second anti-microbial coating 270 of FIGS. 1a, and/or 1b.

Turning to still another alternative embodiment, a method of forming a multilayered film may include providing a first PET substrate, forming a first anti-microbial coating on the first PET substrate, forming a first self-wetting adhesive layer underlying the first PET substrate, and forming at least one peelable multilayered film component overlying the first anti-microbial coating.

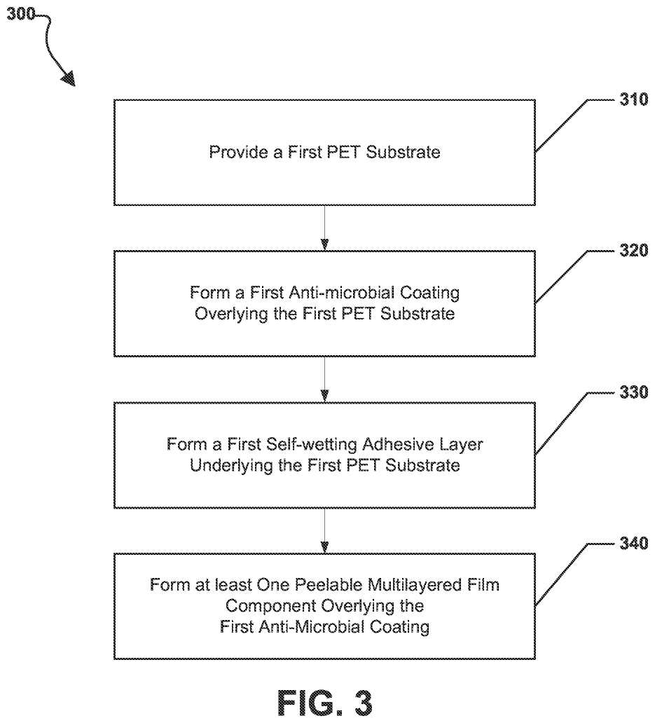

For purposes of illustration, FIG. 3 includes a flow chart showing a method 300 for forming the multilayered film. According to certain embodiments, the method 300 may include a first step 310 of providing a first PET substrate, a second step 320 of forming a first anti-microbial coating overlying the first PET substrate, a third step 330 of forming a first self-wetting adhesive layer underlying the first PET substrate, and a fourth step 340 of forming at least one peelable multilayered film component overlying the first anti-microbial coating.

It will be appreciated that the multilayered film formed according to method 300 may include any of the characteristics or properties of the any embodiment of a multilayered film described herein.

According to certain embodiments, the second step 320 of forming a first anti-microbial coating overlying the first PET substrate may include any known deposition method that can form the first anti-microbial coating on the first PET substrate as described herein.

According to other embodiments, the third step 330 of forming a first self-wetting adhesive layer underlying the first PET substrate may include any known deposition method that can form the first self-wetting adhesive layer underlying the first PET substrate as described herein.

Turning to yet another alternative embodiment, a method of forming a multilayered film may include providing a first PET substrate, forming a first anti-microbial coating on the first PET substrate, forming a first pressure sensitive adhesive layer underlying the first PET substrate, providing a liner underlying the first pressure sensitive adhesive layer, and forming at least one peelable multilayered film component overlying the first anti-microbial coating.

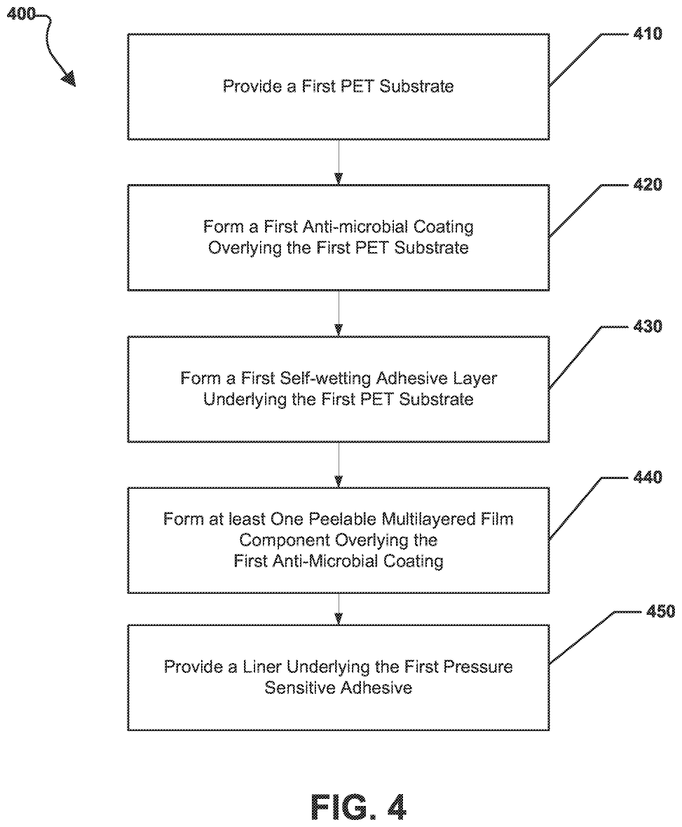

For purposes of illustration, FIG. 4 includes a flow chart showing a method 400 for forming the multilayered film. According to certain embodiments, the method 400 may include a first step 410 of providing a first PET substrate, a second step 420 of forming a first anti-microbial coating on the first PET substrate, a third step 430 of forming a first self-wetting adhesive underlying the first PET substrate, a fourth step 440 of forming at least one peelable multilayered film component overlying the first anti-microbial coating, and a fifth step 450 of providing a liner underlying the first pressure sensitive adhesive.

It will be appreciated that the multilayered film formed according to method 400 may include any of the characteristics or properties of the any embodiment of a multilayered film described herein.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayered film comprising: a first PET substrate; a first anti-microbial coating overlying the first PET substrate; a first self-wetting adhesive layer underlying the first PET substrate; and at least one peelable multilayered film component overlying the first anti-microbial coating, wherein the at least one peelable multilayered film component comprises: a peelable adhesive layer; a second PET substrate overlying the peelable adhesive layer; and a second anti-microbial coating overlying the second PET substrate, wherein the first anti-microbial coating comprises a silver-based filler component within the first anti-microbial coating, wherein the first anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196, wherein the second anti-microbial coating comprises a silver-based filler component within the second anti-microbial coating, wherein the second anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.

Embodiment 2. A multilayered film comprising: a first PET substrate; a first anti-microbial coating overlying the first PET substrate; a first self-wetting adhesive layer underlying the first PET substrate; and at least one peelable multilayered film component overlying the first anti-microbial coating, wherein the at least one peelable multilayered film component comprises: a peelable adhesive layer; a second PET substrate overlying the peelable adhesive layer; and a second anti-microbial coating overlying the second PET substrate, wherein the first anti-microbial coating comprises a silver-based filler component within the first anti-microbial coating, wherein the first anti-microbial coating comprises a silver-based filler component within the first anti-microbial coating, wherein the first anti-microbial coating has an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196, wherein the second anti-microbial coating comprises a silver-based filler component within the second anti-microbial coating, wherein the second anti-microbial coating has an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196.

Embodiment 3. The multilayered film of any one of embodiments 1 and 2, wherein the silver-based filler component of the first anti-microbial coating comprises silver, comprises silver phosphate, comprises a silver containing glass particle.

Embodiment 4. The multilayered film of any one of embodiments 1 and 2, wherein the silver-based filler component of the first anti-microbial coating comprises a mean particle size of at least about 0.01 microns.

Embodiment 5. The multilayered film of any one of embodiments 1 and 2, wherein the silver-based filler component of the first anti-microbial coating comprises a mean particle size of not greater than about 20 microns.

Embodiment 6. The multilayered film of any one of embodiments 1 and 2, wherein the first anti-microbial coating comprises a silver-based filler component content of at least about 0.1 wt. % for a total weight of the first anti-microbial coating.

Embodiment 7. The multilayered film of any one of embodiments 1 and 2, wherein the first anti-microbial coating comprises a silver-based filler component content of not greater than about 2 wt. % for a total weight of the first anti-microbial coating.

Embodiment 8. The multilayered film of any one of embodiments 1 and 2, wherein the first anti-microbial coating further comprises an acrylate-based component and the silver-based filler component is within the acrylate-based component.

Embodiment 9. The multilayered film of embodiment 8, wherein the acrylate-based component of the first anti microbial coating comprises an acrylate monomer.

Embodiment 10. The multilayered film of embodiment 8, wherein the acrylate-based component of the first anti-microbial coating comprises an acrylate oligomer.

Embodiment 11. The multilayered film of embodiment 8, wherein the first anti-microbial coating comprises an acrylate-based component content of at least about 70 wt. % for a total weight of the anti-microbial coating.

Embodiment 12. The multilayered film of embodiment 8, wherein the first anti-microbial coating comprises an acrylate-based component content of not greater than about 98 wt. % for a total weight of the anti-microbial coating.

Embodiment 13. The multilayered film of embodiment 8, wherein the first anti-microbial coating further comprises silicone acrylate.

Embodiment 14. The multilayered film of embodiment 13, wherein the first anti-microbial coating comprises a silicone acrylate content of at least about 0.1 wt. % for a total weight of the first anti-microbial coating.

Embodiment 15. The multilayered film of embodiment 13, wherein the first anti-microbial coating comprises a silicone acrylate content of not greater than about 1 wt. % for a total weight of the first anti-microbial coating.

Embodiment 16. The multilayered film of embodiment 8, wherein the first anti-microbial coating further comprises acrylated silicone.

Embodiment 17. The multilayered film of embodiment 16, wherein the first anti-microbial coating comprises an acrylated silicone content of at least about 0.1 wt. % for a total weight of the first anti-microbial coating.

Embodiment 18. The multilayered film of embodiment 16, wherein the first anti-microbial coating comprises an acrylated silicone content of not greater than about 1 wt. % for a total weight of the first anti-microbial coating.

Embodiment 19. The multilayered film of embodiment 8, wherein the first anti-microbial coating further comprises a fluoro-containing acrylate.

Embodiment 20. The multilayered film of embodiment 19, wherein the first anti-microbial coating comprises a fluoro-containing acrylate content of at least about 10 wt. % for a total weight of the first anti-microbial coating.

Embodiment 21. The multilayered film of embodiment 19, wherein the first anti-microbial coating comprises a fluoro-containing acrylate content of not greater than about 30 wt. % for a total weight of the first anti-microbial coating.

Embodiment 22. The multilayered film of any one of embodiments 1 and 2, wherein the first anti-microbial coating further comprises a UV absorber.

Embodiment 23. The multilayered film of embodiment 22, wherein the first anti-microbial coating comprises a UV absorber content of at least about 0.1 wt. % for a total weight of the first anti-microbial coating.

Embodiment 24. The multilayered film of embodiment 22, wherein the first anti-microbial coating comprises a UV absorber content of not greater than about 10 wt. % for a total weight of the first anti-microbial coating.

Embodiment 25. The multilayered film of any one of embodiments 1 and 2, wherein the first anti-microbial coating further comprises a UV stabilizer.

Embodiment 26. The multilayered film of embodiment 25, wherein the first anti-microbial coating comprises a UV stabilizer content of at least about 0.1 wt. % for a total weight of the first anti-microbial coating.

Embodiment 27. The multilayered film of embodiment 25, wherein the first anti-microbial coating comprises a UV stabilizer content of not greater than about 10 wt. % for a total weight of the first anti-microbial coating.

Embodiment 28. The multilayered film of any one of embodiments 1 and 2, wherein the first anti-microbial coating further comprises an anti-oxidant.

Embodiment 29. The multilayered film of embodiment 28, wherein the first anti-microbial coating comprises an anti-oxidant content of at least about 0.1 wt. % for a total weight of the first anti-microbial coating.

Embodiment 30. The multilayered film of embodiment 28, wherein the first anti-microbial coating comprises an anti-oxidant content of not greater than about 10 wt. % for a total weight of the first anti-microbial coating.

Embodiment 31. The multilayered film of any one of embodiments 1 and 2, wherein the first anti-microbial coating further comprises silica nanoparticles.

Embodiment 32. The multilayered film of embodiment 31, wherein the first anti-microbial coating comprises a silica nanoparticles content of at least about 0.1 wt. % for a total weight of the first anti-microbial coating.

Embodiment 33. The multilayered film of embodiment 31, wherein the first anti-microbial coating comprises a silica nanoparticles content of not greater than about 5 wt. % for a total weight of the first anti-microbial coating.

Embodiment 34. The multilayered film of any one of embodiments 1 and 2, wherein the first anti-microbial coating has an average thickness of at least about 2 microns.

Embodiment 35. The multilayered film of any one of embodiments 1 and 2, wherein the first anti-microbial coating has an average thickness of not greater than about 10 microns.

Embodiment 36. The multilayered film of any one of embodiments 1 and 2, wherein the first anti-microbial coating has a VLT of at least about 88%.

Embodiment 37. The multilayered film of any one of embodiments 1 and 2, wherein the first anti-microbial coating has a VLT of not greater than about 94%.

Embodiment 38. The multilayered film of any one of embodiments 1 and 2, wherein the first anti-microbial coating has a haze value of at least about 0.2%.

Embodiment 39. The multilayered film of any one of embodiments 1 and 2, wherein the first anti-microbial coating has a haze value of not greater than about 2%.

Embodiment 40. The multilayered film of any one of embodiments 1 and 2, wherein the first anti-microbial coating has a water contact angle of at least about 70°.

Embodiment 41. The multilayered film of any one of embodiments 1 and 2, wherein the first anti-microbial coating has a water contact angle of not greater than about 110°.

Embodiment 42. The multilayered film of any one of embodiments 1 and 2, wherein the self-wetting adhesive layer comprises an acrylic-based adhesive, a silicone-based adhesive, or any combination thereof.

Embodiment 43. The multilayered film of embodiment 42, wherein the first self-wetting adhesive layer is an acrylic-based adhesive layer.

Embodiment 44. The multilayered film of embodiment 42, wherein the first self-wetting adhesive layer consists of an acrylic-based adhesive.

Embodiment 45. The multilayered film of embodiment 42, wherein the first self-wetting adhesive layer is a silicone-based adhesive layer.

Embodiment 46. The multilayered film of embodiment 42, wherein the first self-wetting adhesive layer consists of a silicone-based adhesive.

Embodiment 47. The multilayered film of any one of embodiments 1 and 2, wherein the first self-wetting adhesive layer comprises a thickness of at least about 0.5 mils.

Embodiment 48. The multilayered film of any one of embodiments 1 and 2, wherein the first self-wetting adhesive layer comprises a thickness of not greater than about 3 mils.

Embodiment 49. The multilayered film of embodiment 42, wherein the first self-wetting adhesive layer comprises a peel strength of at least about 0.5 g/in.

Embodiment 50. The multilayered film of embodiment 42, wherein the first self-wetting adhesive layer comprises a peel strength of not greater than about 1000 g/in.

Embodiment 51. The multilayered film of embodiment 42, wherein the multilayered film further comprises a liner underlying the first self-wetting adhesive layer.

Embodiment 52. The multilayered film of embodiment 51, wherein the liner comprises a silicone-based layer.

Embodiment 53. The multilayered film of embodiment 51, wherein the liner comprises an average thickness of at least about 1 mil.

Embodiment 54. The multilayered film of embodiment 51, wherein the liner comprises an average thickness of not greater than about 5 mils.

Embodiment 55. The multilayered film of any one of embodiments 1 and 2, wherein the multilayered film further comprises at least one peelable multilayered film component overlying the first anti-microbial coating.

Embodiment 56. The multilayered film of any one of embodiments 1 and 2, wherein the silver-based filler component of the second anti-microbial coating comprises silver, comprises silver phosphate, comprises a silver containing glass particle.

Embodiment 57. The multilayered film of any one of embodiments 1 and 2, wherein the silver-based filler component of the second anti-microbial coating comprises a mean particle size of at least about 0.01 microns.

Embodiment 58. The multilayered film of any one of embodiments 1 and 2, wherein the silver-based filler component of the second anti-microbial coating comprises a mean particle size of not greater than about 20 microns.

Embodiment 59. The multilayered film of any one of embodiments 1 and 2, wherein the second anti-microbial coating comprises a silver-based filler component content of at least about 0.1 wt. % for a total weight of the second anti-microbial coating.

Embodiment 60. The multilayered film of any one of embodiments 1 and 2, wherein the second anti-microbial coating comprises a silver-based filler component content of not greater than about 2 wt. % for a total weight of the second anti-microbial coating.

Embodiment 61. The multilayered film of any one of embodiments 1 and 2, wherein the second anti-microbial coating further comprises an acrylate-based component and the silver-based filler component is within the acrylate-based component.

Embodiment 62. The multilayered film of embodiment 61, wherein the acrylate-based component of the second anti-microbial coating comprises an acrylate monomer.

Embodiment 63. The multilayered film of embodiment 61, wherein the acrylate-based component of the second anti-microbial coating comprises an acrylate oligomer.

Embodiment 64. The multilayered film of embodiment 61, wherein the second anti-microbial coating comprises an acrylate-based component content of at least about 70 wt. % for a total weight of the second anti-microbial coating.

Embodiment 65. The multilayered film of embodiment 61, wherein the second anti-microbial coating comprises an acrylate-based component content of not greater than about 98 wt. % for a total weight of the second anti-microbial coating.

Embodiment 66. The multilayered film of embodiment 61, wherein the second anti-microbial coating further comprises silicone acrylate.

Embodiment 67. The multilayered film of embodiment 66, wherein the second anti-microbial coating comprises a silicone acrylate content of at least about 0.1 wt. % for a total weight of the second anti-microbial coating.

Embodiment 68. The multilayered film of embodiment 66, wherein the second anti-microbial coating comprises a silicone acrylate content of not greater than about 1 wt. % for a total weight of the second anti-microbial coating.

Embodiment 69. The multilayered film of any one of embodiments 1 and 2, wherein the second anti-microbial coating further comprises acrylated silicone.

Embodiment 70. The multilayered film of embodiment 69, wherein the second anti-microbial coating comprises an acrylated silicone content of at least about 0.1 wt. % for a total weight of the second anti-microbial coating.

Embodiment 71. The multilayered film of embodiment 69, wherein the second anti-microbial coating comprises an acrylated silicone content of not greater than about 1 wt. % for a total weight of the second anti-microbial coating.

Embodiment 72. The multilayered film of any one of embodiments 1 and 2, wherein the second anti-microbial coating further comprises a fluoro-containing acrylate.

Embodiment 73. The multilayered film of embodiment 72, wherein the second anti-microbial coating comprises a fluoro-containing acrylate content of at least about 10 wt. % for a total weight of the second anti-microbial coating.

Embodiment 74. The multilayered film of embodiment 72, wherein the second anti-microbial coating comprises a fluoro-containing acrylate content of not greater than about 30 wt. % for a total weight of the second anti-microbial coating.

Embodiment 75. The multilayered film of any one of embodiments 1 and 2, wherein the second anti-microbial coating further comprises a UV absorber.

Embodiment 76. The multilayered film of embodiment 75, wherein the second anti-microbial coating comprises a UV absorber content of at least about 0.1 wt. % for a total weight of the second anti-microbial coating.

Embodiment 77. The multilayered film of embodiment 75, wherein the second anti-microbial coating comprises a UV absorber content of not greater than about 10 wt. % for a total weight of the second anti-microbial coating.

Embodiment 78. The multilayered film of any one of embodiments 1 and 2, wherein the second anti-microbial coating further comprises a UV stabilizer.

Embodiment 79. The multilayered film of embodiment 78, wherein the second anti-microbial coating comprises a UV stabilizer content of at least about 0.1 wt. % for a total weight of the second anti-microbial coating.

Embodiment 80. The multilayered film of embodiment 78, wherein the second anti-microbial coating comprises a UV stabilizer content of not greater than about 10 wt. % for a total weight of the second anti-microbial coating.

Embodiment 81. The multilayered film of any one of embodiments 1 and 2, wherein the second anti-microbial coating further comprises an anti-oxidant.

Embodiment 82. The multilayered film of embodiment 81, wherein the second anti-microbial coating comprises an anti-oxidant content of at least about 0.1 wt. % for a total weight of the second anti-microbial coating.

Embodiment 83. The multilayered film of embodiment 81, wherein the second anti-microbial coating comprises an anti-oxidant content of not greater than about 10 wt. % for a total weight of the second anti-microbial coating.

Embodiment 84. The multilayered film of any one of embodiments 1 and 2, wherein the second anti-microbial coating further comprises silica nanoparticles.

Embodiment 85. The multilayered film of embodiment 84, wherein the second anti-microbial coating comprises a silica nanoparticles content of at least about 0.1 wt. % for a total weight of the second anti-microbial coating.

Embodiment 86. The multilayered film of embodiment 84, wherein the second anti-microbial coating comprises a silica nanoparticles content of not greater than about 5 wt. % for a total weight of the second anti-microbial coating.

Embodiment 87. The multilayered film of any one of embodiments 1 and 2, wherein the second anti-microbial coating has an average thickness of at least about 2 microns.

Embodiment 88. The multilayered film of any one of embodiments 1 and 2, wherein the second anti-microbial coating has an average thickness of not greater than about 10 microns.

Embodiment 89. The multilayered film of any one of embodiments 1 and 2, wherein the second anti-microbial coating has a VLT of at least about 88%.

Embodiment 90. The multilayered film of any one of embodiments 1 and 2, wherein the second anti-microbial coating has a VLT of not greater than about 94%.

Embodiment 91. The multilayered film of any one of embodiments 1 and 2, wherein the second anti-microbial coating has a haze of at least about 0.2%.

Embodiment 92. The multilayered film of any one of embodiments 1 and 2, wherein the second anti-microbial coating has a haze of not greater than about 2%.

Embodiment 93. The multilayered film of any one of embodiments 1 and 2, wherein the second anti-microbial coating has a water contact angle of at least about 70°.

Embodiment 94. The multilayered film of any one of embodiments 1 and 2, wherein the second anti-microbial coating has a water contact angle of not greater than about 110°.

Embodiment 95. A method of forming a multilayered film, wherein the method comprises: providing a first PET substrate; forming a first anti-microbial coating overlying the PET substrate; forming a first self-wetting adhesive layer underlying the first PET substrate; and forming at least one peelable multilayered film component, wherein the at least one peelable multilayered film component comprises: a peelable adhesive layer; a second PET substrate overlying the peelable adhesive layer; and a second anti-microbial coating overlying the second PET substrate, wherein the first anti-microbial coating comprises a silver-based filler component within the first anti-microbial coating, wherein the first anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196, wherein the second anti-microbial coating comprises a silver-based filler component within the second anti-microbial coating, and wherein the second anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.

Embodiment 96. A method of forming a multilayered film, wherein the method comprises: providing a first PET substrate; forming a first anti-microbial coating overlying the PET substrate; forming a first self-wetting adhesive layer underlying the first PET substrate; and forming at least one peelable multilayered film component, wherein the at least one peelable multilayered film component comprises: a peelable adhesive layer; a second PET substrate overlying the peelable adhesive layer; and a second anti-microbial coating overlying the second PET substrate, wherein the first anti-microbial coating comprises a silver-based filler component within the first anti-microbial coating, wherein the first anti-microbial coating has an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196, wherein the second anti-microbial coating comprises a silver-based filler component within the second anti-microbial coating, wherein the second anti-microbial coating has an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196.

Embodiment 97. The method of any one of embodiments 95 and 96, wherein the silver-based filler component of the first anti-microbial coating comprises silver, comprises silver phosphate, comprises a silver containing glass particle.

Embodiment 98. The method of any one of embodiments 95 and 96, wherein the silver-based filler component of the first anti-microbial coating comprises a mean particle size of at least about 0.01 microns.

Embodiment 99. The method of any one of embodiments 95 and 96, wherein the silver-based filler component of the first anti-microbial coating comprises a mean particle size of not greater than about 20 microns.

Embodiment 100. The method of any one of embodiments 95 and 96, wherein the first anti-microbial coating comprises a silver-based filler component content of at least about 0.1 wt. % for a total weight of the first anti-microbial coating.

Embodiment 101. The method of any one of embodiments 95 and 96, wherein the first anti-microbial coating comprises a silver-based filler component content of not greater than about 2 wt. % for a total weight of the first anti-microbial coating.

Embodiment 102. The method of any one of embodiments 95 and 96, wherein the first anti-microbial coating further comprises an acrylate-based component and the silver-based filler component is within the acrylate-based component.

Embodiment 103. The method of embodiment 102, wherein the acrylate-based component of the first anti-microbial coating comprises an acrylate monomer.

Embodiment 104. The method of embodiment 102, wherein the acrylate-based component of the first anti-microbial coating comprises an acrylate oligomer.

Embodiment 105. The method of embodiment 102, wherein the first anti-microbial coating comprises an acrylate-based component content of at least about 70 wt. % for a total weight of the anti-microbial coating.

Embodiment 106. The method of embodiment 102, wherein the first anti-microbial coating comprises an acrylate-based component content of not greater than about 98 wt. % for a total weight of the anti-microbial coating.

Embodiment 107. The method of embodiment 102, wherein the first anti-microbial coating further comprises silicone acrylate.

Embodiment 108. The method of embodiment 107, wherein the first anti-microbial coating comprises a silicone acrylate content of at least about 0.1 wt. % for a total weight of the first anti-microbial coating.

Embodiment 109. The method of embodiment 107, wherein the first anti-microbial coating comprises a silicone acrylate content of not greater than about 1 wt. % for a total weight of the first anti-microbial coating.

Embodiment 110. The method of embodiment 107, wherein the first anti-microbial coating further comprises acrylated silicone.

Embodiment 111. The method of embodiment 110, wherein the first anti-microbial coating comprises an acrylated silicone content of at least about 0.1 wt. % for a total weight of the first anti-microbial coating.

Embodiment 112. The method of embodiment 110, wherein the first anti-microbial coating comprises an acrylated silicone content of not greater than about 1 wt. % for a total weight of the first anti-microbial coating.

Embodiment 113. The method of embodiment 107, wherein the first anti-microbial coating further comprises a fluoro-containing acrylate.

Embodiment 114. The method of embodiment 113, wherein the first anti-microbial coating comprises a fluoro-containing acrylate content of at least about 10 wt. % for a total weight of the first anti-microbial coating.

Embodiment 115. The method of embodiment 113, wherein the first anti-microbial coating comprises a fluoro-containing acrylate content of not greater than about 30 wt. % for a total weight of the first anti-microbial coating.

Embodiment 116. The method of any one of embodiments 95 and 96, wherein the first anti-microbial coating further comprises a UV absorber.

Embodiment 117. The method of embodiment 116, wherein the first anti-microbial coating comprises a UV absorber content of at least about 0.1 wt. % for a total weight of the first anti-microbial coating.

Embodiment 118. The method of embodiment 116, wherein the first anti-microbial coating comprises a UV absorber content of not greater than about 10 wt. % for a total weight of the first anti-microbial coating.

Embodiment 119. The method of any one of embodiments 95 and 96, wherein the first anti-microbial coating further comprises a UV stabilizer.

Embodiment 120. The method of embodiment 119, wherein the first anti-microbial coating comprises a UV stabilizer content of at least about 0.1 wt. % for a total weight of the first anti-microbial coating.

Embodiment 121. The method of embodiment 119, wherein the first anti-microbial coating comprises a UV stabilizer content of not greater than about 10 wt. % for a total weight of the first anti-microbial coating.

Embodiment 122. The method of any one of embodiments 95 and 96, wherein the first anti-microbial coating further comprises an anti-oxidant.

Embodiment 123. The method of embodiment 122, wherein the first anti-microbial coating comprises an anti-oxidant content of at least about 0.1 wt. % for a total weight of the first anti-microbial coating.

Embodiment 124. The method of embodiment 122, wherein the first anti-microbial coating comprises an anti-oxidant content of not greater than about 10 wt. % for a total weight of the first anti-microbial coating.

Embodiment 125. The method of any one of embodiments 95 and 96, wherein the first anti-microbial coating further comprises silica nanoparticles.

Embodiment 126. The method of embodiment 125, wherein the first anti-microbial coating comprises a silica nanoparticles content of at least about 0.1 wt. % for a total weight of the first anti-microbial coating.

Embodiment 127. The method of embodiment 125, wherein the first anti-microbial coating comprises a silica nanoparticles content of not greater than about 5 wt. % for a total weight of the first anti-microbial coating.

Embodiment 128. The method of any one of embodiments 95 and 96, wherein the first anti-microbial coating has an average thickness of at least about 2 microns.

Embodiment 129. The method of any one of embodiments 95 and 96, wherein the first anti-microbial coating has an average thickness of not greater than about 10 microns.

Embodiment 130. The method of any one of embodiments 95 and 96, wherein the first anti-microbial coating has a VLT of at least about 88%.

Embodiment 131. The method of any one of embodiments 95 and 96, wherein the first anti-microbial coating has a VLT of not greater than about 94%.

Embodiment 132. The method of any one of embodiments 95 and 96, wherein the first anti-microbial coating has a haze of at least about 0.2%.

Embodiment 133. The method of any one of embodiments 95 and 96, wherein the first anti-microbial coating has a haze of not greater than about 2%.

Embodiment 134. The method of any one of embodiments 95 and 96, wherein the first anti-microbial coating has a water contact angle of at least about 70°.

Embodiment 135. The method of any one of embodiments 95 and 96, wherein the first anti-microbial coating has a water contact angle of not greater than about 110°.

Embodiment 136. The method of any one of embodiments 95 and 96, wherein the self-wetting adhesive layer comprises an acrylic-based adhesive, a silicone-based adhesive, or any combination thereof.

Embodiment 137. The multilayered film of embodiment 136, wherein the first self-wetting adhesive layer is an acrylic-based adhesive layer.

Embodiment 138. The multilayered film of embodiment 136, wherein the first self-wetting adhesive layer consists of an acrylic-based adhesive.

Embodiment 139. The multilayered film of embodiment 136, wherein the first self-wetting adhesive layer is a silicone-based adhesive layer.

Embodiment 140. The multilayered film of embodiment 136, wherein the first self-wetting adhesive layer consists of a silicone-based adhesive.

Embodiment 141. The method of any one of embodiments 95 and 96, wherein the first self-wetting adhesive layer comprises a thickness of at least about 0.5 mils.

Embodiment 142. The method of any one of embodiments 95 and 96, wherein the first self-wetting adhesive layer comprises a thickness of not greater than about 3 mils.

Embodiment 143. The multilayered film of embodiment 136, wherein the first self-wetting adhesive layer comprises a peel strength of at least about 0.5 g/in.

Embodiment 144. The multilayered film of embodiment 136, wherein the first self-wetting adhesive layer comprises a peel strength of not greater than about 1000 g/in.

Embodiment 145. The multilayered film of embodiment 136, wherein the multilayered film further comprises a liner underlying the first self-wetting adhesive layer.

Embodiment 146. The method of embodiment 145, wherein the liner comprises a silicone-based layer.

Embodiment 147. The method of embodiment 145, wherein the liner comprises an average thickness of at least about 1 mil.

Embodiment 148. The method of embodiment 145, wherein the liner comprises an average thickness of not greater than about 5 mils.

Embodiment 149. The method of any one of embodiments 95 and 96, wherein the silver-based filler component of the second anti-microbial coating comprises silver, comprises silver phosphate, comprises a silver containing glass particle.

Embodiment 150. The method of any one of embodiments 95 and 96, wherein the silver-based filler component of the second anti-microbial coating comprises a mean particle size of at least about 0.01 microns.

Embodiment 151. The method of any one of embodiments 95 and 96, wherein the silver-based filler component of the second anti-microbial coating comprises a mean particle size of not greater than about 20 microns.

Embodiment 152. The method of any one of embodiments 95 and 96, the second anti-microbial coating comprises a silver-based filler component content of at least about 0.1 wt. % for a total weight of the second anti-microbial coating.

Embodiment 153. The method of any one of embodiments 95 and 96, wherein the second anti-microbial coating comprises a silver-based filler component content of not greater than about 2 wt. % for a total weight of the second anti-microbial coating.

Embodiment 154. The method of any one of embodiments 95 and 96, wherein the second anti-microbial coating further comprises an acrylate-based component and the silver-based filler component is within the acrylate-based component.

Embodiment 155. The method of embodiment 154, wherein the acrylate-based component of the second anti-microbial coating comprises an acrylate monomer.

Embodiment 156. The method of embodiment 154, wherein the acrylate-based component of the second anti-microbial coating comprises an acrylate oligomer.

Embodiment 157. The method of embodiment 154, wherein the second anti-microbial coating comprises an acrylate-based component content of at least about 70 wt. % for a total weight of the second anti-microbial coating.

Embodiment 158. The method of embodiment 154, wherein the second anti-microbial coating comprises an acrylate-based component content of not greater than about 98 wt. % for a total weight of the second anti-microbial coating.

Embodiment 159. The method of embodiment 154, wherein the second anti-microbial coating further comprises silicone acrylate.

Embodiment 160. The method of embodiment 159, wherein the second anti-microbial coating comprises a silicone acrylate content of at least about 0.1 wt. % for a total weight of the second anti-microbial coating.

Embodiment 161. The method of embodiment 159, wherein the second anti-microbial coating comprises a silicone acrylate content of not greater than about 1 wt. % for a total weight of the second anti-microbial coating.

Embodiment 162. The method of embodiment 154, wherein the second anti-microbial coating further comprises acrylated silicone.

Embodiment 163. The method of embodiment 162, wherein the second anti-microbial coating comprises an acrylated silicone content of at least about 0.1 wt. % for a total weight of the second anti-microbial coating.

Embodiment 164. The method of embodiment 162, wherein the second anti-microbial coating comprises an acrylated silicone content of not greater than about 1 wt. % for a total weight of the second anti-microbial coating.

Embodiment 165. The method of embodiment 154, wherein the second anti-microbial coating further comprises a fluoro-containing acrylate.

Embodiment 166. The method of embodiment 165, wherein the second anti-microbial coating comprises a fluoro-containing acrylate content of at least about 10 wt. % for a total weight of the second anti-microbial coating.

Embodiment 167. The method of embodiment 165, wherein the second anti-microbial coating comprises a fluoro-containing acrylate content of not greater than about 30 wt. % for a total weight of the second anti-microbial coating.

Embodiment 168. The method of any one of embodiments 95 and 96, wherein the second anti-microbial coating further comprises a UV absorber.

Embodiment 169. The method of embodiment 168, wherein the second anti-microbial coating comprises a UV absorber content of at least about 0.1 wt. % for a total weight of the second anti-microbial coating.

Embodiment 170. The method of embodiment 168, wherein the second anti-microbial coating comprises a UV absorber content of not greater than about 10 wt. % for a total weight of the second anti-microbial coating.

Embodiment 171. The method of any one of embodiments 95 and 96, wherein the second anti-microbial coating further comprises a UV stabilizer.

Embodiment 172. The method of embodiment 171, wherein the second anti-microbial coating comprises a UV stabilizer content of at least about 0.1 wt. % for a total weight of the second anti-microbial coating.

Embodiment 173. The method of embodiment 171, wherein the second anti-microbial coating comprises a UV stabilizer content of not greater than about 10 wt. % for a total weight of the second anti-microbial coating.

Embodiment 174. The method of any one of embodiments 95 and 96, wherein the second anti-microbial coating further comprises an anti-oxidant.

Embodiment 175. The method of embodiment 174, wherein the second anti-microbial coating comprises an anti-oxidant content of at least about 0.1 wt. % for a total weight of the second anti-microbial coating.

Embodiment 176. The method of embodiment 174, wherein the second anti-microbial coating comprises an anti-oxidant content of not greater than about 10 wt. % for a total weight of the second anti-microbial coating.

Embodiment 177. The method of any one of embodiments 95 and 96, wherein the second anti-microbial coating further comprises silica nanoparticles.

Embodiment 178. The method of embodiment 177, wherein the second anti-microbial coating comprises a silica nanoparticles content of at least about 0.1 wt. % for a total weight of the second anti-microbial coating.

Embodiment 179. The method of embodiment 177, wherein the second anti-microbial coating comprises a silica nanoparticles content of not greater than about 5 wt. % for a total weight of the second anti-microbial coating.

Embodiment 180. The method of any one of embodiments 95 and 96, wherein the second anti-microbial coating has an average thickness of at least about 2 microns.

Embodiment 181. The method of any one of embodiments 95 and 96, wherein the second anti-microbial coating has an average thickness of not greater than about 10 microns.

Embodiment 182. The method of any one of embodiments 95 and 96, wherein the second anti-microbial coating has a VLT of at least about 88%.

Embodiment 183. The method of any one of embodiments 95 and 96, wherein the second anti-microbial coating has a VLT of not greater than about 94%.

Embodiment 184. The method of any one of embodiments 95 and 96, wherein the second anti-microbial coating has a haze of at least about 0.2%.

Embodiment 185. The method of any one of embodiments 95 and 96, wherein the second anti-microbial coating has a haze of not greater than about 2%.

Embodiment 186. The method of any one of embodiments 95 and 96, wherein the second anti-microbial coating has a water contact angle of at least about 70°.

### EXAMPLES

The concepts described herein will be further described in the following Examples, which do not limit the scope of the invention described in the claims.

### Example 1

Two sample multilayered films S1 and S2 were formed according to embodiments described herein.

The first sample multilayered film S1 was formed using a #8 Meyer rod to coat an anti-microbial coating solution onto a 7 mil PET film. The anti-microbial coating solution is formed by mixing 1.5 parts by weight of 1-hydroxycyclohexyl phenyl ketone (a photo initiator), 64.83 parts by weight of methyl isobutyl ketone (MIBK), 0.112 parts by weight of acrylated polydimethylsiloxane, acrylated polysiloxane from Evonik Industries, 8.75 parts by weight of urethane acrylate in acrylic monomers, 17.50 parts by weight of Pentaerythritol triacrylate, 6.812 parts by weight of an aliphatic urethane hexaacrylate, 0.221 parts by weight of a photo initiator of Phenyl bis(2,4,6-trimethylbenzoyl)-phosphine oxide and 0.175 parts by weight of sliver phosphate glass. This anti-microbial coating solution has approximately 35.17% solid by weight. The anti-microbial coating solution was dried in an oven at 110° C. for 20 seconds, then cured with UV light to form an anti-microbial hard coat on the PET film. The total thickness of the first sample multilayered film S1 is between 3 and 4 microns.

The second sample multilayered film S2 was formed using a #8 Meyer rod to coat an anti-microbial coating solution onto a 7 mil PET film. The anti-microbial coating solution is formed by mixing 1.20 parts by weight of 1-hydroxycyclohexyl phenyl ketone (a photo initiator), 72.00 parts by weight of methyl isobutyl ketone (MIBK), 0.09 parts by weight of acrylated polydimethylsiloxane, 0.09 parts by weight of acrylated polysiloxane, 7.00 parts by weight of urethane acrylate in acrylic monomers, 14.00 parts by weight of Pentaerythritol triacrylate, 5.45 parts by weight of an aliphatic urethane hexaacrylate, 0.169 parts by weight of a photo initiator of Phenyl bis(2,4,6-trimethylbenzoyl)-phosphine oxide, and 0.16 parts by weight of sliver phosphate glass. The anti-microbial coating solution has approximately 28.12% solid by weight. The anti-microbial coating solution was dried in an oven at 110° C. for 20 seconds, then cured with UV light to form an anti-microbial hard coat on the PET film. The total thickness of the second sample multilayered film S2 is between 2 and 3 microns.

For purposes of comparison, a comparative sample film CS1 were provided.

Comparative sample film CS1 was a 7 mil PET film.

Performance properties of each sample multilayered film S1 and S2 and comparative sample film CS2 were tested and are summarized in Table 1 below. The summarized performance properties include MRSA anti-microbial rating, E. coli antimicrobial rating, VLT, haze, and water contact angle, each tested or measured as described herein.

TABLE 1
Test results of the examples (which were tested
for anti-microbial properties)

| | MRSA | E. Coli | | | | |
|---|---|---|---|---|---|---|
| | Anti- | Anti- | | | | |
| | Microbial | Microbial | | | | |
| | Rating | Rating | | | | |
| | (% | (% | | | | |
| | Reduction | Reduction | | | Thick- | |
| Sam- | Against | Against | | | ness | |
| ple | Initial) | Initial) | VLT | Haze | (μm) | WCA |
| CS1 | 19.55 | None | 90.7 | 1.15 | N/A | 70.6 |
| | | (Growth | | | | |
| | | Shown) | | | | |
| CS2 | 49.34 | None | 92.00 | 1.30 | 8.5-9.5 | 101.7 |
| | | (Growth | | | | |
| | | Shown) | | | | |
| S1 | 99.78 | 99.84 | 92.00 | 1.21 | 3-4 | 102.3 |
| S2 | 99.78 | 99.84 | 91.80 | 0.60 | 2-3 | 100.2 |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayered film comprising:
a first PET substrate;
a first anti-microbial coating overlying the first PET substrate;
a first self-wetting adhesive layer underlying the first PET substrate; and
at least one peelable multilayered film component overlying the first anti-microbial coating,
wherein the at least one peelable multilayered film component comprises:
a peelable adhesive layer;
a second PET substrate overlying the peelable adhesive layer; and
a second anti-microbial coating overlying the second PET substrate,
wherein the first anti-microbial coating comprises a silver-based filler component within the first anti-microbial coating, wherein the first anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196, wherein the second anti-microbial coating comprises a silver-based filler component within the second anti-microbial coating, wherein the second anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.

2. A multilayered film comprising:
a first PET substrate;
a first anti-microbial coating overlying the first PET substrate;
a first self-wetting adhesive layer underlying the first PET substrate; and
at least one peelable multilayered film component overlying the first anti-microbial coating,
wherein the at least one peelable multilayered film component comprises:
a peelable adhesive layer;
a second PET substrate overlying the peelable adhesive layer; and
a second anti-microbial coating overlying the second PET substrate,
wherein the first anti-microbial coating comprises a silver-based filler component within the first anti-microbial coating, wherein the first anti-microbial coating comprises a silver-based filler component within the first anti-microbial coating,
wherein the first anti-microbial coating has an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196,
wherein the second anti-microbial coating comprises a silver-based filler component within the second anti-microbial coating,
wherein the second anti-microbial coating has an E. coli anti-microbial rating of at least about 75%, where the E. coli anti-microbial rating is defined as the percent reduction of Escherichia coli (E. coli) activity from an initial inoculation of E. coli on the surface of the anti-microbial layer after 24 hours as measured using ISO22196.

3. The multilayered film of claim 1, wherein the silver-based filler component of the first anti-microbial coating comprises silver, comprises silver phosphate, comprises a silver containing glass particle.

4. The multilayered film of claim 1, wherein the silver-based filler component of the first anti-microbial coating comprises a mean particle size of at least about 0.01 microns.

5. The multilayered film of claim 1, wherein the silver-based filler component of the first anti-microbial coating comprises a mean particle size of not greater than about 20 microns.

6. The multilayered film of claim 1, wherein the first anti-microbial coating comprises a silver-based filler component content of at least about 0.1 wt. % for a total weight of the first anti-microbial coating.

7. The multilayered film of claim 1, wherein the first anti-microbial coating comprises a silver-based filler component content of not greater than about 2 wt. % for a total weight of the first anti-microbial coating.

8. The multilayered film of claim 1, wherein the first anti-microbial coating further comprises an acrylate-based component and the silver-based filler component is within the acrylate-based component.

9. The multilayered film of claim 8, wherein the acrylate-based component of the first anti microbial coating comprises an acrylate monomer.

10. The multilayered film of claim 8, wherein the acrylate-based component of the first anti-microbial coating comprises an acrylate oligomer.

11. The multilayered film of claim 8, wherein the first anti-microbial coating comprises an acrylate-based component content of at least about 70 wt. % for a total weight of the anti-microbial coating.

12. The multilayered film of claim 8, wherein the first anti-microbial coating comprises an acrylate-based component content of not greater than about 98 wt. % for a total weight of the anti-microbial coating.

13. The multilayered film of claim 8, wherein the first anti-microbial coating further comprises silicone acrylate.

14. The multilayered film of claim 13, wherein the first anti-microbial coating comprises a silicone acrylate content of at least about 0.1 wt. % for a total weight of the first anti-microbial coating.

15. The multilayered film of claim 13, wherein the first anti-microbial coating comprises a silicone acrylate content of not greater than about 1 wt. % for a total weight of the first anti-microbial coating.

16. The multilayered film of claim 8, wherein the first anti-microbial coating further comprises acrylated silicone.

17. The multilayered film of claim 16, wherein the first anti-microbial coating comprises an acrylated silicone content of at least about 0.1 wt. % for a total weight of the first anti-microbial coating.

18. The multilayered film of claim 16, wherein the first anti-microbial coating comprises an acrylated silicone content of not greater than about 1 wt. % for a total weight of the first anti-microbial coating.

19. The multilayered film of claim 8, wherein the first anti-microbial coating further comprises a fluoro-containing acrylate.

20. A method of forming a multilayered film, wherein the method comprises:
providing a first PET substrate;
forming a first anti-microbial coating overlying the PET substrate;
forming a first self-wetting adhesive layer underlying the first PET substrate; and
forming at least one peelable multilayered film component,
wherein the at least one peelable multilayered film component comprises:
a peelable adhesive layer;
a second PET substrate overlying the peelable adhesive layer; and
a second anti-microbial coating overlying the second PET substrate,
wherein the first anti-microbial coating comprises a silver-based filler component within the first anti-microbial coating,
wherein the first anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196,
wherein the second anti-microbial coating comprises a silver-based filler component within the second anti-microbial coating, and
wherein the second anti-microbial coating has a MRSA anti-microbial rating of at least about 75%, where the MRSA anti-microbial rating is defined as the percent reduction of methicillin-resistant Staphylococcus aureus (MRSA) activity from an initial inoculation of MRSA on the surface of the anti-microbial layer after 24 hours as measured using ISO22196.
